(19) United States
(12) Patent Application Publication
(10) Pub. No.: US 2002/0078621 A1
(43) Pub. Date: Jun. 27, 2002

(54) Method and system for gas based extermination of mound building hymenoptera

(75) Inventor: Allen C. Jones, Ocala, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: BIO-TRAX, INC., OCALA, FL

(21) Appl. No.: 10/008,299

(22) Filed: Nov. 13, 2001

Related U.S. Application Data
(60) Provisional application No. 60/258,375, filed on Dec. 22, 2000.

(51) Int. Cl. A01M 1/00

(52) U.S. Cl. 43/124

(57) ABSTRACT

A method and system which exterminates mound building ants (Hymenoptera) such as imported red fire ants in situ their mound by changing a carbon dioxide gas concentration of an ambient atmosphere within the mound through a ground probe. This gas based method and system is novel due to its speed of extermination and due to the lack of toxic chemical residues left in the soil or environment. The method and system is suitable for use by homeowners or commercial enterprises and renders extermination of imported red fire ants economical and efficient. Treatment of one mound with the system taught in this patent disclosure is expected to cost as little as one fourth as much as use of currently prevailing methods.

### CROSS REFERENCE TO RELATED APPLICATIONS

This application is based upon and claims priority from prior U.S. Provisional Patent Application No. 60/258,735, filed Dec. 22, 2000, the entire disclosure of which is herein incorporated by reference.

### TECHNICAL FIELD

This invention relates in general to methods for controlling mound building ants, and more particularly to a method for gas based extermination of imported red fire ant mounds (Solenopsis invicta).

### DESCRIPTION OF THE PRIOR ART

The imported red fire ant is a major economic problem in warmer areas of the United States, particularly from North Carolina right around the southern most tiers of states to California. Red fire ants exhibit several behaviors that make them a particularly noxious pest in the environment. They are mound builders whose mounds may rise two feet above the surrounding terrain and contain hundreds of thousands of ants. These mounds may become hardened to such a degree as to damage mowing and farming equipment that may contact them.

Of even greater concern is the behavior of the ants when the mound is disturbed. The ants will swarm out of the mound and attack the intruder. The sting of these ants leaves small skin irritations or bumps that are easily infected. Since it is usual to experience multiple bites numbering tens, hundreds, or thousands at each attack, the multiple bites become a major personal nuisance and may leave scarring on the skin of the victim. Some persons experience severe to fatal reactions to the stings. When such attacks occur on the grounds of a public place, liability may occur to the management. Furthermore, the attacks also occur upon farm animals especially to the young that may blunder into or lie upon such mounds. Death or scarring may result with negative economic impact. Furthermore, there is an additional risk that should a poisonous chemical control compound be used in a pasture, that the animals might lick or otherwise ingest the compound as they graze and to their detriment.

Red imported fire ants therefore are a major nuisance and annoyance for homeowners, golf courses, resorts, amusement parks, hotels, farms, and ranches. Numerous chemicals are sold for fire ant control and these are commonly a poisonous dust that is sprinkled onto or watered into the mound. Such chemicals typically do not work immediately but may require the ants carry the compound back into the mound or require the transport of several pounds of water per mound for washing the chemical into the recesses of the mound. Some of the compounds are sensitive to ant activity, ambient temperature, or the presence of dew on the ground. The death of a queen is suspected to alert those remaining in the mound to evacuate with any remaining viable eggs. Therefore, treatment of a mound may result in the appearance of another mound in close proximity within several days. Chemical control methods have a history of poor success with fire ants as aerial spraying to control their spread has failed since the 1950's. Furthermore, the chemical compounds which are currently approved for use on fire ant mounds are coming under increasing regulatory scrutiny and could be eliminated in the future.

The US government has identified a tiny parasitic wasp from South America that lays its eggs in the heads of red fire ants. Upon hatching, the larva will eat the contents of the fire ant's head and kill it. Experimental releases of this wasp are planned in 2001 with a five-year program aimed at putting this wasp into the fire ant environments across the US. None-the-less, the wasp is only expected to discourage the red imported fire ant population and it is publicly acknowledged that the wasps will not eradicate imported red fire ants. Anyone stepping on a mound, even though the imported wasp is in the vicinity, will still be subjected to the swarming attack of the colony. Between government programs, commercial applications, and homeowner use, many hundreds of millions of dollars are spent in the US each year on fire ant control. Short of folk remedies such as pouring boiling water down the mound, a product has not existed which would economically and instantly eradicate the occupants of a fire ant mound. To accomplish this would require that the queen, eggs, and substantial numbers of the fire ants be rapidly killed in situ the mound which none of the prevailing methods accomplish.

Prior art that attempts to achieve results include such work as U.S. Pat. No. 4,597,217. This work discloses a method for suffocating field mice under the ground by introducing liquid nitrogen into a burrow. The liquid nitrogen will sublimate into a gas and theoretically fill the mound. However, transport and use of liquid nitrogen is problematical in small quantities and the gas sublimates imperfectly for suffocation in downward sloping cavities, as it is lighter than air. U.S. Pat. No. 4,640,044 discloses a transparent cover by means of which solar energy is used to destroy ants by heat. However, this implementation is passive in action and weather dependent. Furthermore the generated heat may be insufficient to penetrate the mound sufficiently to kill the queens. The slowly rising temperature under the cover may in fact force the ants from the mound. U.S. Pat. No. 4,768,306 discloses a method of killing fire ants through use of poisonous carbon monoxide. This method incurs considerable danger to the operator and renders it unsuitable for use by the public at large. U.S. Pat. No. 4,833,818 discloses a method of exterminating subterranean animals including fire ants through use of a cover and carbon dioxide. This patent teaches a method that always requires as much as “several” minutes to treat a mound but may also require as much as 60 to 90 minutes. Furthermore, its use of standard pressures and low flow rates as the gas settles into the mound could require as much as 25 standard cubic feet of carbon dioxide to treat one fire ant mound. A readily portable cylinder could only treat about 4 mounds at such gas consumption before it was necessary to refill. Movement of larger cylinders to each mound would require motorized transport.

In addition, U.S. Pat. No. 4,637,161 discloses a method of injecting steam into the ground through a shield to kill insects or animals. U.S. Pat. No. 4,667,436 discloses an apparatus to electrocute ants within a mound. U.S. Pat. No. 3,029,558 discloses a method of fumigating under a cover.

### BRIEF DESCRIPTION OF THE DRAWINGS

FIG. 1 is a block diagram illustrating an exemplary system, in accordance with a preferred embodiment of the present invention.

FIG. 2 is a Flow Diagram of the steps in a typical mound treatment.

### DESCRIPTION OF THE PREFERRED EMBODIMENTS

This invention utilizes new methods and processes for an ant extermination system to effectively control and eliminate mound-building ants. A significant advantage of the present method and system is that the extermination can occur in less than 30 seconds of elapsed time without the use of poisons through use of a novel ground probe in conjunction with a protective shield.

In accordance with a preferred embodiment of the present invention, using carbon dioxide to exterminate ants in situ their mounds is a sound process. Carbon dioxide is colorless, odorless, and tasteless. It is commonly used to provide the “fizz” in carbonated soft drinks and is necessary for plant respiration. Carbon dioxide occurs naturally in the environment and is also produced as a by-product of certain chemical industries. Once used to exterminate an ant mound, the carbon dioxide will sublimate rapidly into the atmosphere where it naturally occurs at a fraction of one per cent by volume. It will not be detectable nor will it leave a toxic residue. In the extermination of most ant mounds a variable volume of carbon dioxide of approximately 0.25 standard cubic foot will be released. As the ants respire carbon dioxide gas, the gas will rapidly enter their circulatory system and further acidify it such that they expire from both asphyxiation and acidosis.

This new and novel process, according to the present invention, will provide a more effective, rapid, and safer process for dealing with unwanted mound building ants for both consumers and commerce.

### Definitions

1. Acidosis: Poisoning by acids forming within a body. For the purposes of this invention this means a chemical change to the circulatory fluids in an imported red fire ant's body by which they are infused with carbon dioxide, which increases the acidity of the circulatory fluids such that the exoskeleton can no longer contain them.

2. Ambient Air: The mixture of gases common to a specific locale and comprising nitrogen, oxygen, trace gases, water vapor, and various pollutants but sufficient to support life.

3. Ant Mound: A mound of soil excavated by mound building ants such as imported red fire ants and in which the ant colony and its queen live. The home mound will be aggressively protected by imported red fire ants.

4. Asphyxiate: The act of suffocating a living organism by reducing the residual oxygen available to that organism to the point that it expires due to oxygen starvation.

5. Controllable Gas Port: A valve that is manually opened or closed for starting or stopping the communication of carbon dioxide from the gas container through the gas line to the ground probe.

6. Exterminate (Extermination): The act of killing ants within or on top of their mound.

7. Gas Container: Any container that may be used to hold or retain any gas or mixture of gases of any purity in either a gaseous or liquid phase. The container may be portable or fixed and of any pressure rating.

8. Gas Line: Any rigid or flexible system of piping through which a pure or blended gas which is not substantially ambient air may be communicated from the Gas Container to the Ground Probe.

9. Gas Pressure Regulator: A mechanical device which is common in the industrial gas trade and which is used to reduce the pressure of compressed or liquefied gases held in the Gas Container down to safe levels for operation. The Gas Pressure Regulator may or may not have a dial or gauge for determination of pressure in the Gas Container and it may or may not be preset at a prescribed delivery pressure.

10. Ground Probe: Any instrument of such a size and design to easily penetrate the soil in an ant mound and which by its design will present the substantially carbon dioxide gas into the core of the ant mound. A feasible probe being of diameter of substantially from 1/64″ to 2 inches of internal diameter.

11. Shield. A device, which fits over the Ground Probe and serves to protect the gas entering the mound from either being wafted away by any wind or breeze or being sublimated rapidly into the atmosphere. The shield serves a secondary function of providing a barrier to prevent the imported red fire ants from attacking the user. The shield is held onto the ground by spring pressure.

### Exemplary Structural Description

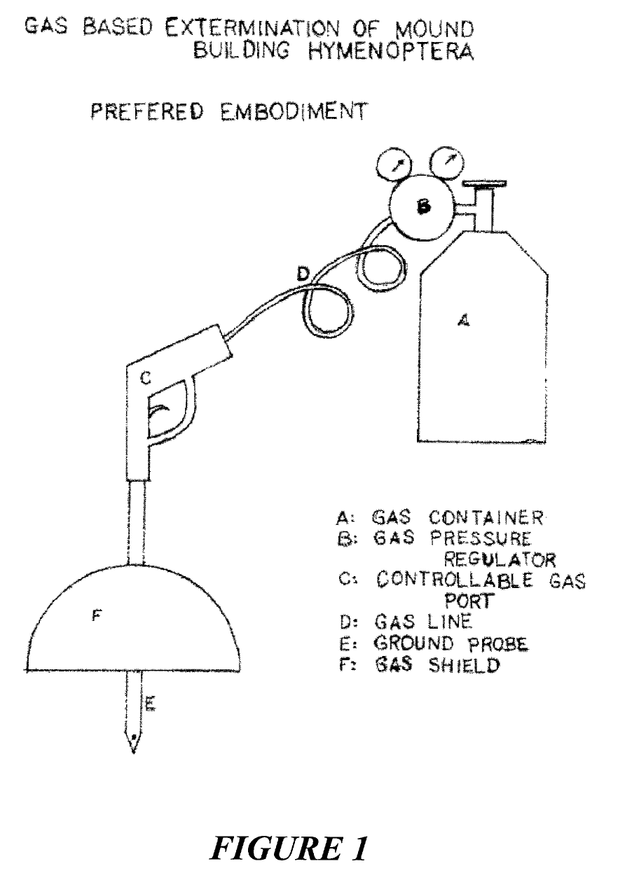

The major components of the invention when used for extermination of mound building ants is shown is FIG. 1. An easily transported source of carbon dioxide is necessary and this is held in gas container “a.” Gas container “a” communicates with a gas pressure regulator “b.” and communicates with the controllable gas port “c” through gas line “d.” The controllable gas port “c” communicates with the ground probe “e” and the gas shield “f” falls over the ground probe “e” as it enters the mound and is held in tight contact with the ground by spring pressure.

### Exemplary Treatment Steps

1. Check to be sure that the gas pressure regulator is attached to the gas container and that all parts are correctly assembled.

2. Fully open valve at top of gas container but do not attempt to reset the gas flow pressure, which is preset.

3. Move the mound treating apparatus to the vicinity of the first ant mound to be treated.

4. Depress trigger on the controllable gas port and insert the ground probe into the approximate center of the ant mound (it may be necessary to use more or less force and move the ground probe in a circular motion to achieve complete entry).

5. Continue to insert the ground probe until the gas shield is in contact with the ground and the spring is depressed.

6. Hold the ground probe in the mound with the trigger of the controllable gas port fully depressed for at least 10 seconds or until the ants under the shield have retreated into the mound and activity under the gas shield has substantially ceased. This may take as long as 30 seconds or more depending upon time of day, weather conditions, or prevailing temperatures.

7. Release the trigger and remove the ground probe from the mound.

8. Move to the vicinity of the next mound and repeat steps 4 through 8.

9. When mound treatments are finished, close the valve at the top of the gas container and store the unit out of the weather.

### Functional Description

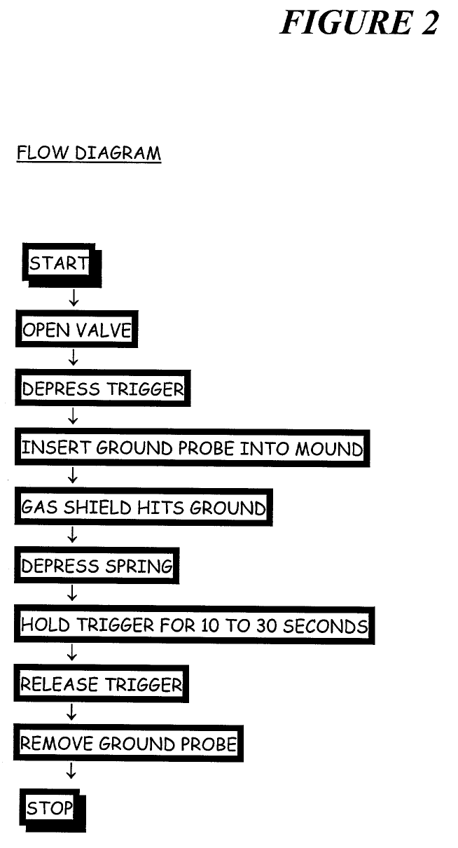

Referring now also to FIG. 2, when a mound building ant colony such as of imported red fire ants is to be exterminated, the apparatus in FIG. 1 is carried or rolled to the proximity of the mound. The gas pressure regulator “b” on the gas container “a” is opened to a preset maximum pressure of 30 psi. The ground probe “e” is placed on the mound and the controllable gas port “c” is opened as the probe is inserted into the mound, preferably to the maximum depth as determined by contact of the gas shield “f” with the ground around the mound and full depression of the spring above gas shield “f.” A ground probe of ⅛″ tubular material is efficient in sandy soils. The controllable gas port “c” is kept open so that carbon dioxide may enter the mound for a time of not less than 10 seconds nor more than 60 seconds. Imported red fire ants will be observed to initially surge from the mound to attack the ground probe “e” and the gas shield “f.” The contact of ground shield “f” with the ground around the mound will act to greatly prevent the ants from reaching the operator in an all-out attack. However, they will also be observed to quickly retreat into the mound in response to the danger to their queen as the carbon dioxide flows into the mound. Carbon dioxide will be allowed to flow into the mound until ant activity has substantially ceased which normally takes no more than 30 seconds at temperatures above 70° F. At these conditions, approximately 0.25 standard cubic feet of gas will be consumed in treating one imported red fire ant mound. The controllable gas port “c” is then closed and the ground probe “e” is withdrawn from the mound. The soil of the mound may then be manually drawn back over the mound to seal it.

This invention offers substantial advantages over the previous art. While previous inventions have relied upon standard pressure and temperature and allowed the gas to slowly seep into the mound so as not to alarm the mound, they have entailed larger volumes of gas consumed and longer treatment times. Under the best treatment conditions taught in U.S. Pat. No. 4,833,818, this technology might use 300% as much gas and take 10 times as long. Under the maximum treatment conditions taught in the U.S. patent '818, gas consumption will be 5000% more and it will take 180 times as long. On the other hand, for the present invention, a readily portable gas container can treat 150 to 200 imported red fire ant mounds and in areas saturated with such mounds approximately 30 may be treated in one hour. The previous art teaches that it is necessary to not alarm the fire ants of one's actions. This may have been necessary because other patents have addressed a plurality of burrowing mammals and insects and not alarming a gopher such that he escapes is of greater concern than when the technology is specific to imported red fire ants. Moreover, the technology of the present invention uses an alarm of the mound to an advantage. The novel use of a ground probe coupled with an integral shield to isolate the gas and ants from the user allows the process to be conducted speedily and with a fraction of the gas otherwise employed. It has been discovered that when the ground probe enters the mound, the ants will surge out to attack and be largely physically restrained by the shield. The concurrent injection of gas below the surface of the mound is apparently very quickly perceived as a greater threat, perhaps by some communication from the dying queen or her workers. The surging ants then rush back into the mound to the area of greatest gas concentration and perish within seconds. An examination of the mound will find the imported red fire ants curled into tight balls and dead. Ants that were outside the mound foraging may continue to return for some minutes. However, the mound is effectively destroyed and will not be reoccupied.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method for exterminating at least one ant in a mound, the method comprising the steps of:
Introducing gas comprising carbon dioxide gas into an ant mound; and
Changing, by introducing the gas, the concentration of carbon dioxide in the ambient atmosphere of the mound sufficient to exterminate at least one ant that respires the ambient atmosphere.

2. The method of claim 1, further comprising the step of containing the gas comprising carbon dioxide around the ant mound with a partial enclosure that is held in close contact with the earth by spring pressure.

3. The method of claim 1, further comprising the step of introducing the gas comprising carbon dioxide into the interior of the mound with an easily introduced probe to reach near proximity to the queen in the center of the mound.

4. The method of claim 1, wherein the step of introducing the gas into the mound is conducted at low pressures and small volumes such as do not pose health and safety concerns but still to allow rapid demise of the ants. Pressures may range from 5 psi to as much as 60 psi and volumes from 0.1 to 10 standard cubic feet.

5. The method of claim 1, wherein the changing step comprises the step of killing at least one ant that respires the ambient atmosphere causing acidosis of its circulatory system.

6. The method of claim 1, wherein the changing step comprises the step of asphyxiating at least one ant that respires the ambient atmosphere.

7. The method of claim 1, wherein the changing step comprises the step of changing the ambient atmosphere to a concentration of carbon dioxide that is substantially at least 20% of the at least partially contained ambient atmosphere.

8. The method of claim 1, wherein the changing step comprises the step of changing the ambient atmosphere to a concentration of carbon dioxide that is substantially 50% of the at least partially contained ambient atmosphere.

9. A gas based, readily portable, and simple-to-use ant extermination system comprising:
a small diameter ground probe for introducing the gas comprising substantially carbon dioxide into the ant mound, the diameter of said probe may vary according to the prevailing soil compaction into which it must be inserted without undue effort or damage to the probe, and the probe being of diameter of substantially from 1/64″ to 2 inches of internal diameter;
a shield to contain the gas at least partially within the vicinity of the mound and protect it from immediate wafting by air currents or immediate sublimation into the atmosphere, the same shield affording a degree of physical protection to the user from attack by swarming ants;
a controllable gas port to allow gas introduction into the mound for brief time periods;
a gas line communicating with the gas source and the controllable gas port; and
a gas container containing a gas comprising a concentration of carbon dioxide, the gas container being mechanically coupled to the gas line and the controllable gas port.

10. A method for exterminating at least one ant in a mound, the method comprising the steps of:
treating an ant mound with a gas, and
wherein the treatment is concluded and the at least one ant exterminated within 30 seconds from start of gas flow into the ant mound.

11. The method of claim 10, wherein the ant's natural behavior to attack an intruder is interrupted by the flow of the gas and wherein the ant retreats to within the mound.

12. The method of claim 10, wherein the treating step employs no poisons and no toxic residue remains after the treatment is concluded.
